(19) United States
(12) Patent Application Publication
(10) Pub. No.: US 2009/0295197 A1
(43) Pub. Date: Dec. 3, 2009

(54) Apparatus and Method For Reducing Undesirable Air Flow in a Passenger Compartment of a Vehicle

(75) Inventors: Jeff Zabel, Palo Alto, CA (US); Florian Drasch, Muenchen (DE); Sven Klussmann, Eichenau (DE); Michael Charwat, Fuerstenfeldbruck-Aich (DE); Thomas Meiwald, Muenchen (DE); Daniel Paulus, Schmallenberg (DE); Atsushi Suzuki, Stanford, CA (US); Benno Wurm, Karlsruhe (DE); Joshua Arvizu, Greensboro, NC (US); Mark Bianco, Mountain Avenue, CA (US); Brian Biggott, Palisades, CA (US); Martin Bodi, Muenchen (DE)

Correspondence Address: SHUTTLEWORTH & INGERSOLL, P.L.C., 115 3RD STREET SE, SUITE 500, P.O. BOX 2107, CEDAR RAPIDS, IA, 52406, US

(73) Assignee: Bayerische Motoren Werke Aktiengesellschaft aCorporation

(21) Appl. No.: 12/087,886

(22) PCT Filed: Jan. 31, 2007
(86) PCT No.: PCT/US2007/002435

§ 371 Date: Jul. 6, 2009

Related U.S. Application Data
(60) Provisional application No. 60/763,369, filed on Jan. 31, 2006.

(51) Int. Cl. B60K 37/00

(52) U.S. Cl. 296/208; 296/70

(57) ABSTRACT

A method and apparatus for reducing undesirable air flow in a passenger compartment of a forward moving vehicle taps into an external air stream source to provide a counteractive air flow supply. The counteractive air flow supply is used to introduce at least one generally forward to rearward directed counteractive flow of air into the passenger compartment at a generally laterally central portion of the vehicle in an amount and at a velocity sufficient to counteract at least a portion of a rearward to forward flow of air in the passenger compartment to provide a forward to rearward directed flow of air through a generally laterally central portion of the passenger compartment at a head level of at least one front seat passenger.

This application claims priority to U.S. Provisional Patent Application No. 60/763,369, filed Jan. 31, 2006 and entitled “Vehicle Wind Deflector”, the entirety of which is incorporated herein by reference.

### BACKGROUND OF THE INVENTION

The present invention relates to convertible automobiles, and more specifically, to air flow through the passenger compartment when the convertible top is lowered.

Convertible automobiles, or convertibles for short, are very popular for the open-air driving experience that they provide when the convertible top is lowered and the automobile passengers are further exposed to the wind and sky. However pleasant this experience is, uncontrolled wind flow in the passenger compartment can buffet the passengers and detract from the experience. Such buffeting can be a general annoyance to the passengers and disrupt hair and clothing, hamper vision and increase the passenger compartment sound level so that it is more difficult to communicate with other passengers and hear the radio, for example.

The buffeting is caused by a low pressure zone in the passenger compartment that causes some of the air/wind moving from front to back around the passenger compartment to recirculate from back to front through the passenger compartment, generally through the lateral center of the passenger compartment. This recirculation is shown generally in the schematic view of FIG. 1. There, it can be seen how wind flowing by the outside of the passenger compartment recirculates into the passenger compartment between the two rear seats (i.e., through the lateral center of the automobile) and moves forward in the passenger compartment. FIG. 2 shows a Computational Fluid Dynamics (“CFD”) model developed by the present applicant that shows this recirculating wind flow through the passenger compartment in greater detail than FIG. 1. As can be seen in the CFD model, the wind recirculates from back to front through the center of the vehicle, between the left and right passenger seating positions, to the front of the passenger compartment where it encounters the rear surface of the windshield and changes direction, causing the air to swirl about the front passenger seating positions, thereby buffeting the front passengers. Throughout this specification, the term “passenger” can include the driver of the automobile, unless specifically noted. Depending on the vehicle design, speed and other factors, the center of recirculation and height of buffeting can move forward or backward in the passenger compartment and be more pronounced to the front or rear seat passengers.

Certain convertible automobiles attempt to address this problem by deflecting or blocking this rear to front recirculation of wind in the passenger compartment. Generally, they do this by positioning a wind deflector rearward of the front passengers. The wind deflector may be positioned in front of the rear seats, if any, or behind the rear seats.

One such type of deflector is used on certain BMW® 2-seat and 4-seat convertible automobiles. The deflector is an aftermarket accessory that can be installed to improve the comfort of the passenger compartment. This type of deflector operates to block wind backflow recirculation created by the low pressure zone in the passenger compartment. The deflector uses a mesh screen to diffuse this recirculation air flow and reduce turbulence in the passenger compartment. This has a positive impact on wind velocity, noise and perceived temperature in the passenger compartment.

However, this deflector has a number of drawbacks. When used for the 4-seat convertibles, it installs above the rear seats, making these seats unusable for passengers while the deflector is installed and thereby reducing the occupancy of the automobile. Such a deflector is shown in FIG. 3 (Prior Art). The deflector also makes it difficult to place bags, briefcases or other parcels in the rear seats for storage.

In addition, this type of manually installed deflector takes a substantial amount of time for installation and can be rather complex for an inexperienced user, requiring a substantial list of directions to teach the inexperienced user the proper installation/removal techniques. Even with extensive directions, improper understanding of the directions and/or incorrect installation, are not uncommon. The deflector can also be difficult to install by just one person and the automobile must be stopped for installation/removal. For installation, the deflector must be removed from its storage location, removed from its protective container, unfolded and snapped together. This can be awkward and users are known to place the deflector on the ground or in/on the automobile during assembly/disassembly, which can result in scratches or other damage to the deflector, automobile paint, trim or interior. The top must be lowered to install the deflector and requires the user to close slightly, and then re-open the roof again to secure the deflector in place. Overall, the process can take an experienced user in excess of one minute and a normal user from three to five minutes, or longer.

When the deflector is used in 4-seat convertibles, it is necessary to make the deflector removable to access and use the rear seats. The deflector is fairly large and uses considerable space when stored in the trunk. Heavy or sharp items placed on the deflector when stored can damage the deflector, so this further limits the usability of the trunk space when the deflector is stored therein. To help protect the deflector from damage, a storage bag is provided. However, placing the deflector in the bag can be difficult and users are again known to place the bag on the ground or automobile to place the deflector in the bag. In addition, this type of deflector can reduce rear visibility. Although the deflector is a black mesh to allow users to see through it, the deflector can still dim and compromise the rear visibility for the driver/passengers. Other types of wind deflectors are known that can be automatically raised and lowered, but these generally require relatively complex, expensive and/or heavy operating mechanisms.

In addition, thus deflector can even perform too well in reducing air movement in the passenger compartment. That is, if the deflector reduces the air movement in the passenger compartment too much, positive attributes of the open air convertible experience can be lost for the vehicle passengers and the experience can become more like that of an enclosed (hard top or top up) vehicle.

Wind deflectors of the nature discussed above are disclosed in U.S. Pat. No. 5,318,337 to Götz, entitled “Windscreen Arrangement For A Convertible” and issued Jun. 7, 1994; and German Patent Application DE 197 05 682 A1.

### SUMMARY OF THE INVENTION

The present invention is an apparatus and method for reducing undesirable air flow in a passenger compartment of a vehicle.

The apparatus and method for reducing undesirable air flow in a passenger compartment of a forward moving vehicle taps into an external air stream source to provide a counteractive air flow supply. The counteractive air flow supply is used to introduce at least one generally forward to rearward directed counteractive flow of air into the passenger compartment at a generally laterally central portion of the vehicle in an amount and at a velocity sufficient to counteract at least a portion of a rearward to forward flow of air in the passenger compartment to provide a forward to rearward directed flow of air through a generally laterally central portion of the passenger compartment at an upper body level (generally including the head, chest and shoulders) of at least one front seat passenger.

Such forward to rearward directed flow of air provides a pleasant convertible experience for the passengers. It helps reduce buffeting of hair and clothes, especially around the sensitive face and head area of the passengers, helps maintain a comfortable cabin temperature and helps reduce noise and unpleasant sounds resulting from the buffeting.

Objects of the present invention will be apparent from the above and the attached description of the invention, including the figures.

The invention will be described in further detail below in conjunction with the attached figures, wherein like reference numerals indicate like components.

### BRIEF DESCRIPTION OF THE DRAWINGS

FIG. 1 is a schematic view of recirculation of wind into the passenger compartment of a convertible automobile with the top down;

FIG. 2 is a Computational Fluid Dynamics (“CFD”) model that shows the recirculation of wind into the passenger compartment in greater detail than FIG. 1;

FIG. 3 (Prior Art) shows a rear elevational view of a known type of wind deflector installed on a convertible automobile;

FIG. 4 is a table showing “good wind” characteristics versus “bad wind” characteristics;

FIG. 5 is a perspective view of a first embodiment of the present invention installed in a convertible automobile;

FIG. 6 is a further perspective view of the embodiment of FIG. 5 and including a schematic graphic showing an interior construction of the embodiment;

FIG. 7 is a detailed side view of the embodiment of FIG. 5;

FIG. 8 is a schematic view showing operation of the flap valve of the embodiment of FIG. 5, with the flap valve shown in the open position;

FIG. 9 is a further schematic view showing operation of the flap valve of the embodiment of FIG. 5, with the flap valve shown in the closed position;

FIG. 10 is a schematic view similar to FIG. 1 showing the effect of the present invention;

FIG. 11 is a schematic top and side view of recirculation of wind into the passenger compartment of a convertible automobile with the top down;

FIG. 12 is a schematic top and side view similar to FIG. 11 showing the effect of the present invention;

FIG. 13 is a graphical representation of the relative wind speeds and directions in the vehicle (taken at typical front passenger face, shoulder and elbow heights) depending on whether the embodiment of FIG. 5 is off or on;

FIG. 14 is a table showing temperature measurements in the cabin (top down) when using the embodiment of FIG. 5, as measured at 65 miles per hour on a clear (sunny) day and clear night with the noted use of the climate control system;

FIG. 15 is a graph showing a pair of superimposed sound wave forms, one measured when the embodiment of FIG. 5 is off and one measured when it is on;

FIG. 16 is a table showing various dimensions of the embodiment of FIG. 5;

FIG. 17 is a schematic view of a filter embodiment using mesh screens angled at 30, 45, and 90 degrees from the horizontal;

FIG. 18 is a graph showing the head losses for the different filter embodiments disclosed herein;

FIG. 19 is a schematic view of a labyrinth type filter embodiment;

FIG. 20 is a schematic view of an elbow type filter embodiment;

FIG. 21 is a schematic view of a fan type filter embodiment; and

FIGS. 22-25 are partial schematic views showing various inlet positions and ducting arrangements for the present invention.

### DETAILED DESCRIPTION OF THE INVENTION

An analysis of user expectations for a premium convertible experience has found that as much as people enjoy an open-air motoring experience and the feeling of freedom that it offers, the wind inside the cabin can contribute to both the enjoyment of the experience, as well as detract therefrom. Wind can affect both sound and touch factors for the passengers. Sound inputs are annoying when they drown out our conversations or music, exceed some innate loudness threshold, or are inconsistent and unpredictable (buffeting). The sound of wind noise, the environment, and the vehicle are otherwise a pleasurable and necessary element of the positive convertible experience.

Touch is what truly indicates to the passenger that he/she is in a convertible. The wind through one's hair is pleasurable, until it musses the hair or interferes with the safe operation of the vehicle. Similarly, the impression of temperature is pleasurable when in a comfortable range but unpleasurable and distracting when it ventures into extremes of cold or hot. Ideally, wind would remain, but would not mess hair or make the passengers excessively cold or warm. The pulse and flow of that wind would also remain nearly constant, or proportional with vehicle speed, as random variations in the wind can be distracting and unpleasant.

From this, it has been found that wind in the passenger compartment can be generally classified into two classifications: “good wind” and “bad wind”. “Good wind” has been found to be wind that generally blows from front to back and is consistent. Good wind creates additional wind noise in the passenger compartment but such wind noise is not overpowering and does not drown out the radio or passenger conversation. Good wind also does not overcome the temperature control system of the automobile, so that a desired passenger compartment temperature can be maintained.

“Bad wind” is wind that flows from the back to the front of the passengers and especially around the passengers' heads, and also flows irregularly. Bad wind creates increased and even overpowering wind noise on the passenger compartment, along with buffeting or popping sounds. Bad wind can also overcome the temperature control system of the automobile, such that the passenger compartment is too hot or too cold. Bad wind that flows irregularly causes buffeting, which is not only distracting to the passenger but can also cause buffeting of the hair and clothes. Testing has shown that the face and head area are most sensitive to bad wind and it is this area of the passenger that can benefit the most from good wind.

Various factors for good wind and bad wind are shown in the table of FIG. 4. Thus, this table can be used to judge the quality of the convertible experience and the effectiveness of a solution to the problem. Ideally, the solution would improve upon the weak points of the wind deflector and selectively filter out those elements of the experience that were unpleasant. To positively increase the convertible experience for passengers, it has been found that it is necessary to have a certain level of good wind while reducing or eliminating the bad wind. Eliminating both the good wind and the bad wind gives an experience more similar to driving in a closed automobile and detracts from the convertible experience for most passengers.

In one embodiment for reducing wind buffeting in the passenger compartment of a convertible automobile or other vehicle, a frontward to rearward flow of air is introduced into a front portion of the passenger compartment, preferably at a generally laterally central portion between the left and right seats. This flow of air counteracts the generally rearward to forward flow of air present in convertibles that is irritating and distracting to vehicle passengers (i.e., the “bad wind”). The forward to rearward flow of air introduced into the passenger compartment to counteract the bad wind will be referred to herein as the “counteractive air flow”.

The counteractive air flow can be tapped from any convenient source. In one embodiment, the counteractive air flow air passes through a ducting system in a lower portion of the front windshield and is supplied by the air stream outside the vehicle in front of the windshield. In this embodiment, the counteractive air flow exits the ducting system into the passenger compartment at generally the same height as the height of the exterior air stream that is tapped to provide the counteractive air flow. This embodiment was used for testing because of the ease of adapting a prototype to a vehicle but is not presently considered to be an embodiment that will be commercially offered.

In a presently preferred embodiment, the ducting for the counteractive air flow is arranged so that an exit portion for the ducting, or ducting outlet, is provided below windshield height, either in the dashboard, at dashboard height or even below a dashboard height. In one version of such an arrangement, the ducting is routed beneath the level of the windshield to the source air stream. An advantage of such an arrangement is that the ducting does not limit forward visibility for the driver/passenger, as would an embodiment that flows air through ducting in the windshield.

Further, the ducting system can be arranged in the vehicle to tap into an air stream at other portions of the vehicle, such as, inter alia, in front of the vehicle, at the sides of the vehicle, underneath the vehicle or below the windshield. The ducting system can have one or more inlets to tap into an air stream source at one or more positions. Multiple inlets may be positioned in the same general area of the vehicle or in different general areas of the vehicle. The amount of bad wind, and its negative effect on passengers, generally increases with the speed of the vehicle. Therefore, it is advantageous to provide a source air stream for the counteractive air flow that also increases with the speed of the vehicle.

The flow area of the ducting system for the counteractive air flow can be restricted in any known manner from inlet(s) to outlet(s) to increase the velocity of the counteractive air flow. The restriction can be variable to adjust the velocity of the air flow. It is also intended that the ducting system include a damper or valving arrangement so that the counteractive air flow can be turned off and on, as desired, and/or so that the amount of the counteractive air flow can be controlled, as desired. The placement, number and size of the system inlet(s) can be adjusted as necessary to provide a desired volume and velocity of counteractive air flow in the vehicle.

It is contemplated that the counteractive air flow may be provided as a single flow of air from a single duct, or can include flows of air from multiple ducts or multiple outlets. Thus, the system can have one or more inlets and one or more outlets, selected as desired for the specific vehicle application. The outlet or outlets can be adjustable so as to be able to adjust a direction of the counteractive air flow. The multiple outlets can be arranged at generally the same height in the vehicle or can be arranged at different heights in the vehicle, and can be directed to provide counteractive air flow at different heights in the passenger compartment.

In a presently preferred embodiment, the ducting for the counteractive air flow is completely separate from ducting for the climate control (HVAC) system of the vehicle.

The present invention is different from the prior art deflector type devices described in the background section because it introduces a front to rear air mass flow into the passenger compartment to reduce or eliminate wind recirculation/counterflow in the passenger compartment and around the passenger(s), and even create a positive front to rear air mass flow around/adjacent the passenger(s), rather than using a physical shield to block such air recirculation.

In a first prototype embodiment of the present invention, as discussed above, the counteractive air flow outlet is positioned at a level of a lower portion of the windshield and ducting for the air flow therefore passes through or under the windshield (or, can even pass to one or both sides or over the top of the windshield). For aesthetic purposes and to integrate well with the interior of the vehicle, the counteractive air flow outlet preferably does not extend beyond, or substantially beyond, the rear surface of the adjacent dashboard.

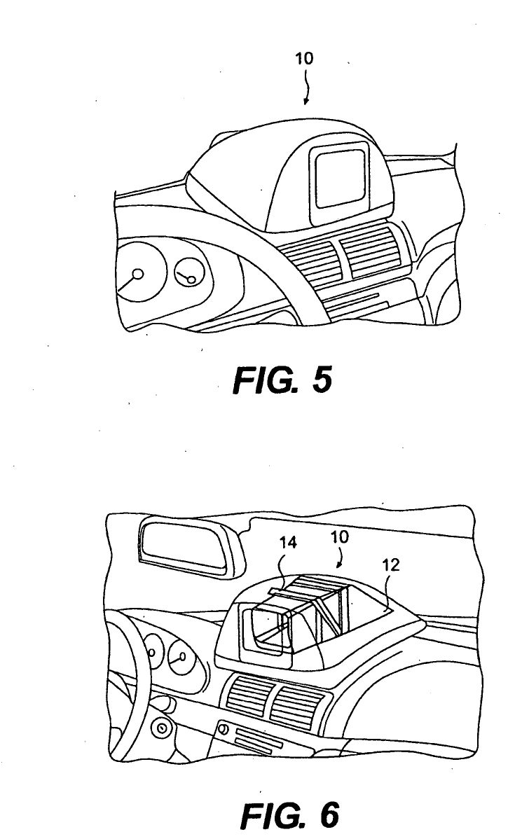

A working model of this first embodiment is shown in FIGS. 5-7. It is noted that this embodiment was a testing prototype used to test the effectiveness of the concept. While this testing prototype embodiment or a similar embodiment could be used with a production vehicle, it is presently anticipated that an alternative embodiment will be used in future production vehicles that, inter alia, better integrates with the interior of the vehicle, the space and other constraints imposed by other vehicle components and systems and which does not have ducting passing directly through the windshield.

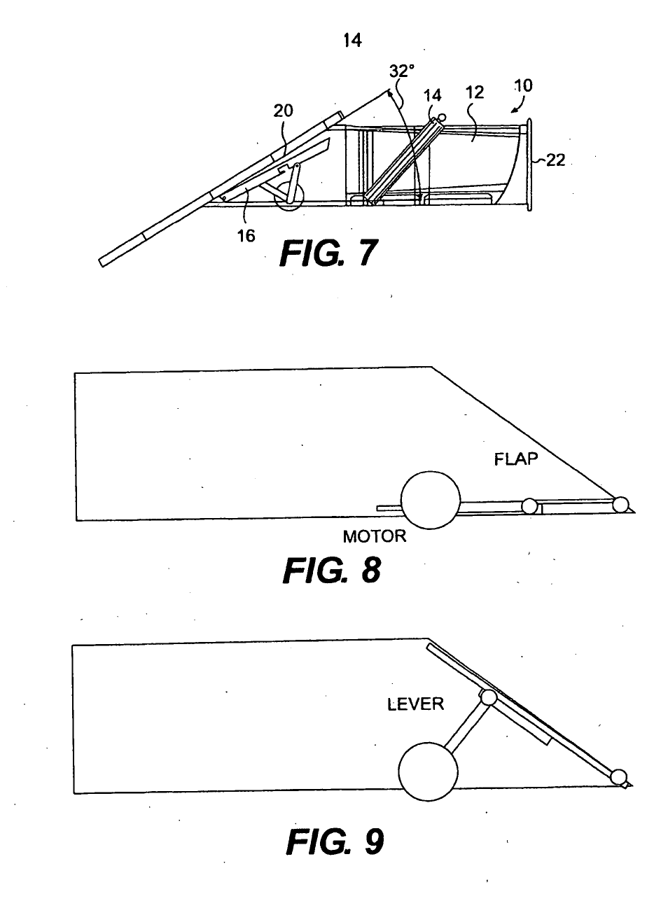

FIG. 5 is an exterior perspective view of the counteractive air flow system 10. See also FIGS. 6-7. The system 10 includes ducting 12 that passes through a lower portion of the windshield to receive air flow from the front of the windshield when the vehicle is moving. Ducting 12 has an inlet 20 and outlet 22 (see also FIG. 7). FIG. 6 shows the same embodiment with an included schematic graphic showing an interior construction of the system 10, including the ducting 12 and a filtering element 14. The filtering element 14 can slide in to a channel in the ducting 12 for ease of removal, cleaning and replacement. An insulated removable cover surrounds the ducting 12 to reduce noise and to better integrate the system 10 with the interior of the vehicle. FIG. 7 also shows a flap valve 16 that can be used with the system 10 to open and close the ducting 12. The ducting 12 has a slight convergence from front to back to assist in straightening the counteractive air flow exiting the outlet 22 to assist in counteracting the bad wind.

FIGS. 8 and 9 are schematic views showing how the motor and lever operated flap valve 16 operates. FIG. 8 shows the flap valve in an open position and FIG. 9 shows the flap valve in a closed position. Other valve types can also be used and can either operate in a full open/closed manner or can also operate so as to open the valve to any position between full open and full closed (inclusive), so as to be able to adjust the amount of counteractive air flow, and thus, the effect of the counteractive air flow. These valves can be electrically or pneumatically controlled, manually controlled or controlled in other manners. In a preferred embodiment, a control interface, such as a knob, lever, video screen interface, BMW® iDrive® control, voice control, or other type of interface, is placed in the cabin so that the system can be selectively and progressively controlled by a passenger.

The system can also use a CPU, logic circuit or other electronic control unit to automatically control the system under certain circumstances. For instance, a rain sensor can be used to close the system 10 when rain is detected so that rain/moisture is prevented from entering the cabin through the system 10. The system 10 can also be automatically controlled so that its operation is dependent upon a roof position or a vehicle speed. For example, the system 10 can be prevented from opening when the roof is up, the vehicle is stopped or traveling at a low speed, or the vehicle is traveling in excess of a predetermined speed. A proximity sensor positioned near the system outlet can also be incorporated, so that the system 10 automatically closes, preventing air flow therethrough, when the proximity sensor detects that a passenger has moved into the path of the outlet air flow. This would prevent the flow of air from the outlet directly impacting the passenger. Such control might also be tied in with a temperature sensing unit so that it only operates when the outside air is significantly cooler or warmer than an interior cabin temperature. The proximity sensor might also be automatically controlled to operate if the vehicle is traveling in excess of a predetermined speed.

The system 10 can also incorporate some form of secondary climate control system, so that the outside air entering the cabin is either cooled or heated depending on the outside temperature and interior cabin temperature. Such a climate control system would assist the vehicle's primary climate control system in keeping a comfortable interior cabin temperature when the counteractive air system 10 is being used. The secondary climate control system would preferably be controllable by a vehicle passenger as to whether it is operating or not, and to the extent that it heats or cools the incoming flow of air. In an alternative embodiment, the counteractive air flow system is incorporated with the vehicle's primary climate control system.

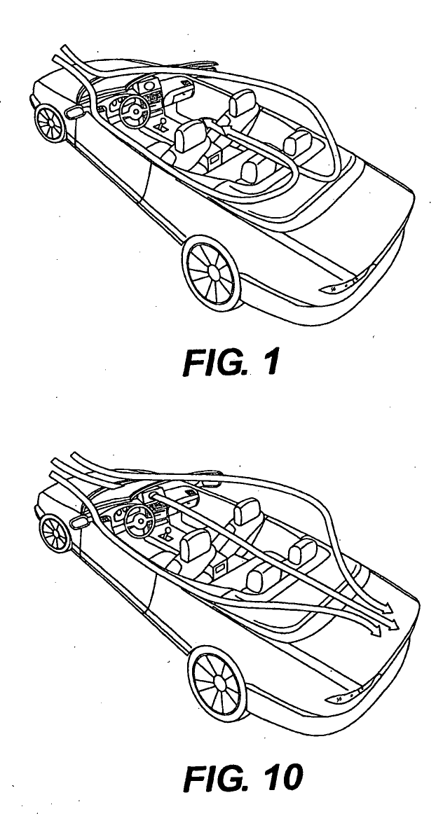

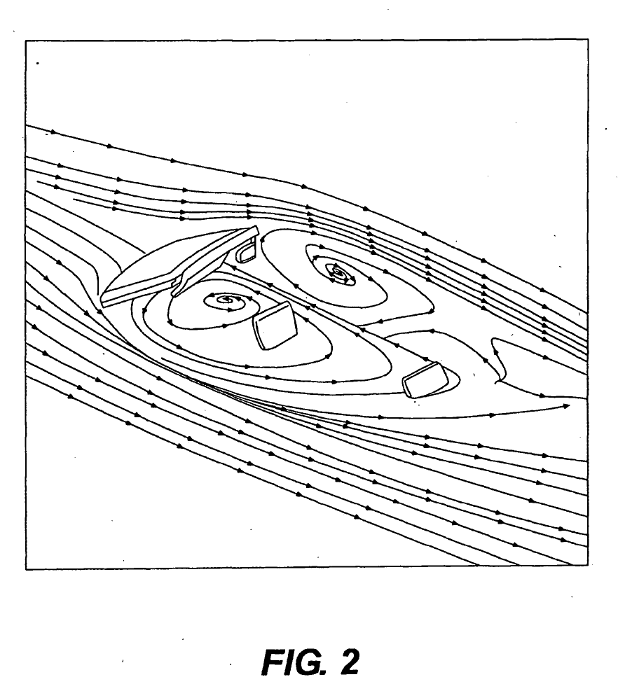

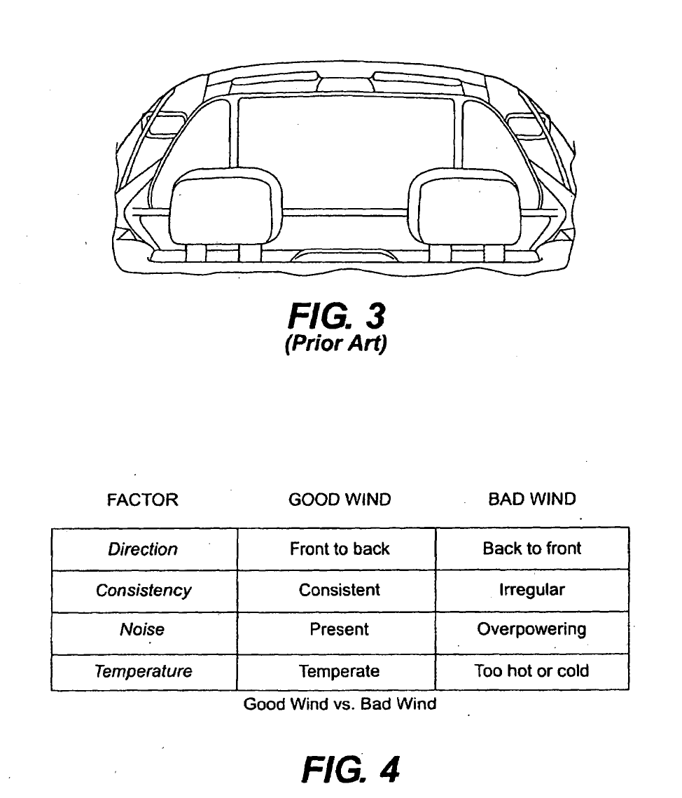

The counteractive effect of the system 10 is shown schematically in FIG. 10, positioned below FIG. 1, for comparison. The counteractive air flows from the front of the windshield, through the ported windshield and the counteractive air flow system 10 to enter the vehicle at a laterally central portion above the dashboard. The flow continues rearward between the passenger seats to counteract the rearward to forward air flow (bad wind) and produce a good wind effect for the passengers.

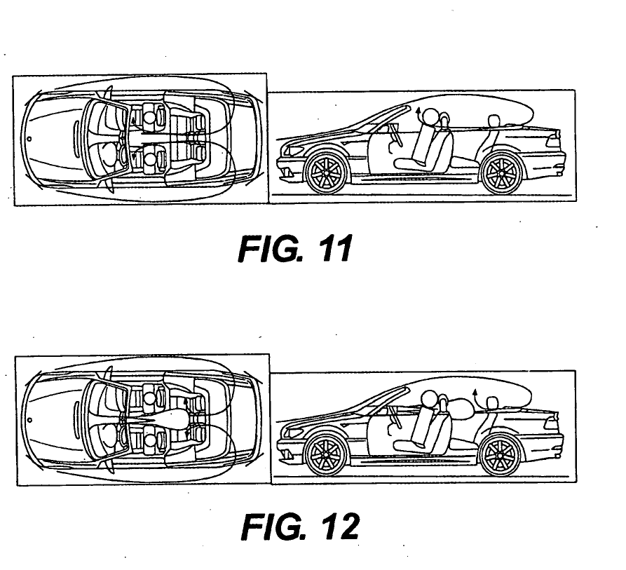

See also, FIGS. 11 and 12. FIG. 11 shows overhead and side schematic views of a representative convertible and the air flows around and into the passenger compartment when the vehicle is moving forward and the counteractive air flow system is off. The bad wind is clearly seen as entering from the rear of the vehicle and moving forward in the cabin. FIG. 12 shows the same schematic views with the counteractive air flow system on. Here, it can be seen how the counteractive air flow through the system 10 counteracts the bad wind and provides a good wind experience for at least the front passengers.

The system produces a uniform counteractive air flow that pushes the recirculation/bad wind back to midway between the rear seats and the back of the front seats, creating a calm atmosphere in the front of the cabin. The system's precisely tuned counteractive air flow all but avoids the front passengers but for a light brush on the inside shoulders, which user testing has shown only adds to the fun of the open air experience. The passengers are left feeling a gentle wind that tickles their head and enhances the convertible ride. Testing has shown this embodiment to work best for passengers in a two seat automobile or for front seat passengers in a four seat automobile. It is also possible that the system can be selectable to provide a laterally offset counteractive air flow (toward the driver) when only a driver is in the vehicle, to maximize the driver's comfort.

In an alternative embodiment, a secondary counteractive air system can be used having outlets installed in the cabin at about the position of the backs of the front seats. Such a system can be used in conjunction with the primary counteractive air flow system 10 to more effectively counteract bad wind effecting rear seat passengers without having to increase air velocity and flow from the primary system 10 to an extent that it could become distracting to front seat passengers. The secondary system can have outlets installed in the back portions of the front seats or in a floor console between the seats, or elsewhere in the same general mid longitudinal position of the cabin. The secondary system can also have an outlet installed generally between the rear seat head rests. The secondary system can be separately controllable or controlled so as to act in a complementary manner to the primary system 10. For instance, use of the secondary system could reduce the demand on the primary system and allow the primary system to operate at a lower rate.

Although in the embodiment tested, the air flow exits the duct at about 24 m/s, (measured at 65 mph or 30 m/s), from an approximately 4″×3″ (10.2 cm×7.6 cm) area, the average velocity of the good wind felt by the front passengers is much gentler than the bad wind felt in the base case (i.e., without counteractive air flow). The combination of outlet area, position, and exit velocity is important in obtaining optimal performance from the system. It is also important to note the difference in air flow directions between the base case (counteractive air flow off) and the inventive case (counteractive air flow on).

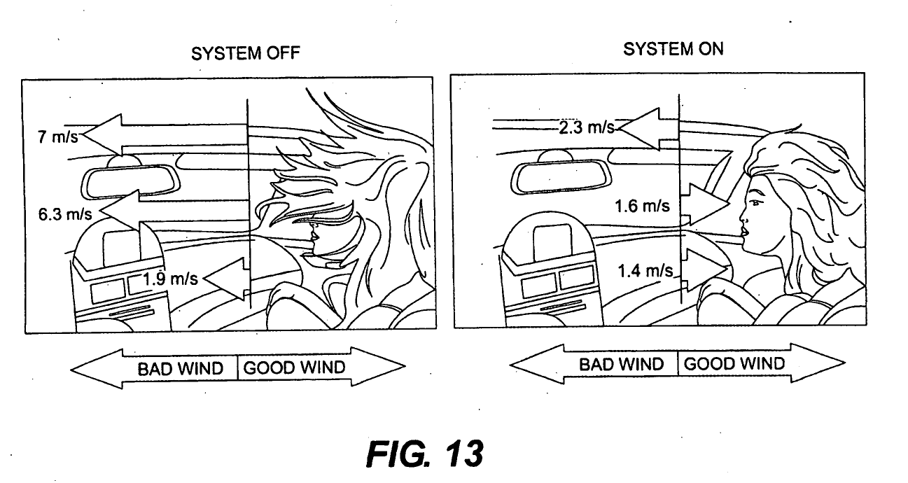

FIG. 13 shows a graphical representation of the relative wind speeds and directions in the vehicle (taken at typical front passenger face, shoulder and elbow heights) depending on whether the system is off or on. In the inventive case, the wind flows from front to back, as indicated by the right-pointing arrows, which is a significant improvement over the back to front wind in the base case, as indicated by the left-pointing arrows. As can be seen in the system on measurements (right side), a substantial portion of the bad wind has been replaced by good wind and the remaining bad wind has been substantially diminished in magnitude so as to be less of an irritant to the passengers.

The wind speed and direction can vary depending on the conditions of the weather, traffic, and time of day. These factors can also affect the results of the system felt by the front passengers. One large difference observed was measurements taken during the day versus those taken at night. An approximately 1 m/s drop in the wind speed touching front passengers in nighttime tests was recorded because surface and crosswinds were much calmer and allowed the system to work more effectively. Such diminishments in velocities would still result in positive gains of good wind over bad wind and an enhancement of the convertible experience.

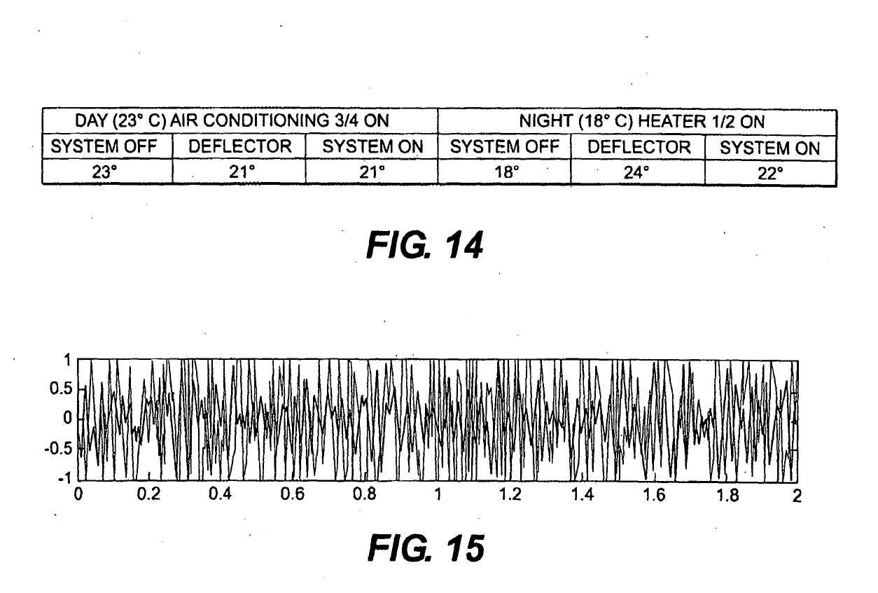

The cabin temperature tremendously affects the passenger's perception of the open air experience. If the temperature is too low the experience becomes chilly and unpleasant; too high and the environment becomes clammy and uncomfortable. The counteractive air flow system 10 compliments the standard climate control system by reducing some external recirculation around the passengers without stifling the climate, as compared to the prior art wind deflector. See FIG. 14, which shows temperature measurements in the cabin (top down), as measured at 65 miles per hour on a clear (sunny) day and clear night with the noted use of the climate control system.

By reducing the recirculation in the cabin, the counteractive air flow system 10 also decreases the uncomfortable buffeting heard by the front seat passengers. FIG. 15 shows sound waveforms recorded near the inside ear of a front passenger. The darker waveform is recorded with the system 10 off and the lighter waveform is recorded with the system 10 on. Not only is the significant decrease in noise intensity apparent when the system 10 is on, but the system 10 also eliminates the buffeting characterized by the random high level spikes in the darker (base case) waveform. By decreasing the wind noise and eliminating wind buffeting, the system 10 creates a convertible experience that allows passengers to carry a conversation or enjoy their music without raising their voices or straining to overcome the ambient wind noise.

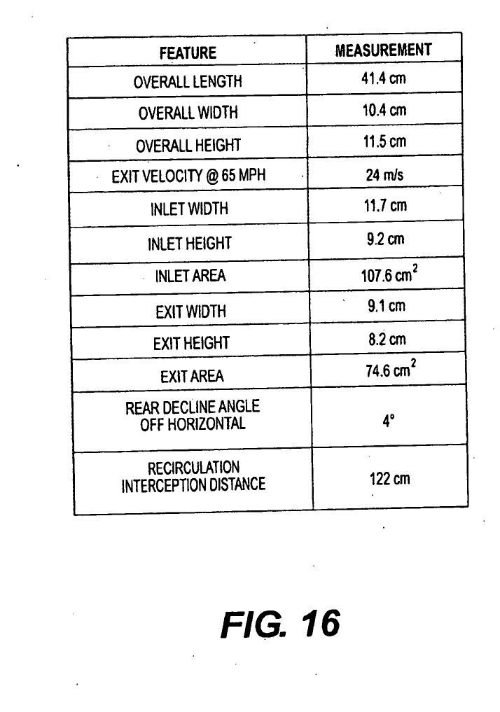

FIG. 16 shows basic dimensions for the first embodiment of the counteractive air system duct discussed above.

The counteractive air flow ducting and outlet can include some amount of convergence (as discussed above) or even divergence, but best results have been found where the counteractive air flow at the outlet is of a generally uniform nature. Disturbances in the counteractive air flow ducting and/or outlet that detract from this uniform air flow, or even cause turbulent air flow, have been found to detract from the performance of system. That is, less uniform and even turbulent counteractive air flow from the outlet has been found to be less effective at counteracting the rearward to forward air flow/bad wind than a uniform and more laminar counteractive air flow from the outlet. Vanes or other types of flow straighteners can be used within the counteractive air flow ducting and/or outlet to assist in straightening the counteractive air flow exiting the outlet. They can even be made adjustable to some degree for adjusting an angle of the counteractive air flow into the vehicle although too much adjustability can conceivably allow adjustment to an angle that is less effective or even ineffective in counteracting the bad wind in the vehicle.

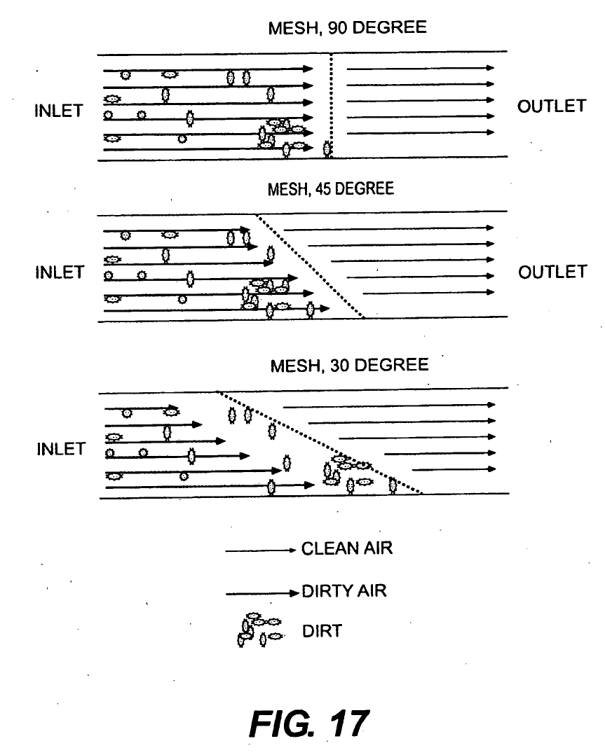

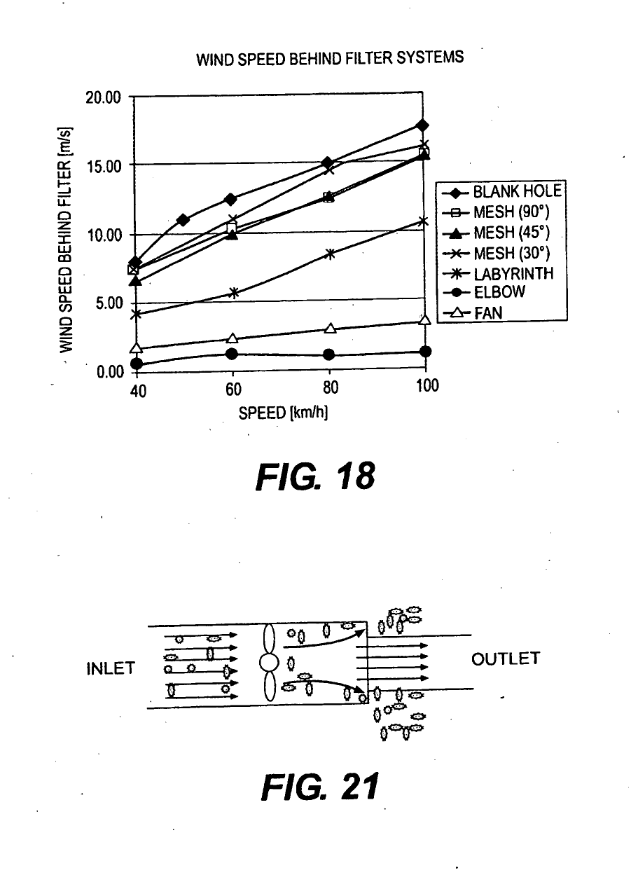

As discussed above, the system preferably uses one (or more) filter(s) positioned in the counteractive air flow ducting to filter out unwanted particles from the flow or to otherwise affect the flow in a desired manner. Filtering the air stream can be a compromise, balancing filter effectiveness with head loss (and thus duct effectiveness) and added system noise. Several prototype models of filters were tested for effectiveness. As discussed above, in the prototype test embodiment, an angled mesh screen was found to provide the best performance. FIG. 17 shows such an embodiment using mesh screens angled at 30, 45, and 90 degrees from the horizontal. Testing has shown that in particular examples of the above and below-noted filter embodiments, the angled mesh filters had the least head loss. See FIG. 18. The testing has shown that placing the filter at an inclined angle of 30-45° helps dramatically reduce head loss over an upright configuration (90°). One mesh that was used with good results was a FH 734-8A Vivid View® Screen Fabric from Gore Technology®, which yielded minimal hindrance to air flow and created minimal noise.

In addition, the further the filter is positioned toward the rear of the duct, the louder the resulting noise and the more turbulent the exiting air flow becomes, making the duct less effective. As the filter is moved toward the front of the duct, audible noise is reduced, airspeed out of the duct is increased, and air flow is more uniform as it exits the duct. However, placing the filter too close to the entrance of the duct causes an entrance effect where the air bypasses the duct entirely, causing a dramatic reduction in air flow. The high frequency broadband noise produced by the filter mesh can be acceptable if it remains constant over time such that it “disappears” into the background. Placing the mesh far inside the duct helped shield the mesh from side-wind or highway gusts that would upset this regularity.

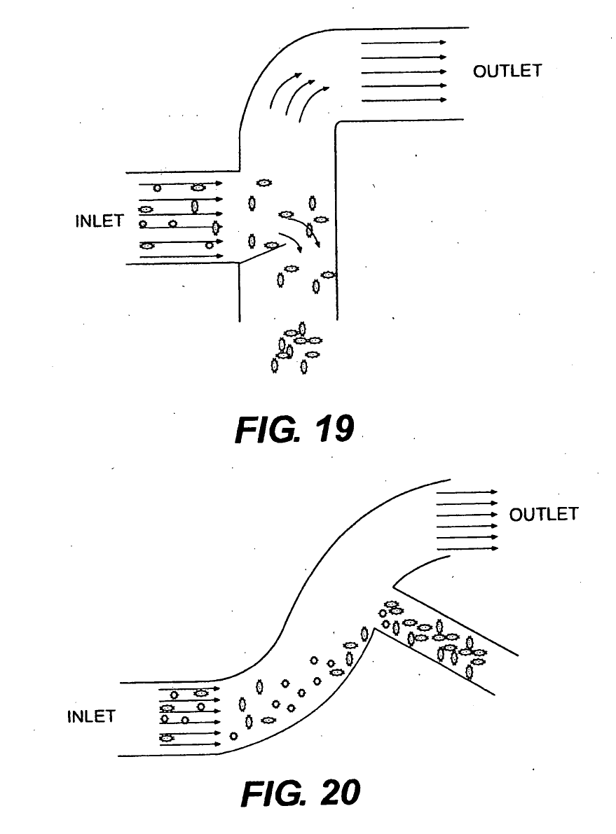

Other filter arrangements were also tested that might be more appropriate for alternative embodiments of the system 10 that have longer ducting paths. These include a labyrinth type as shown in FIG. 19 where the ducting changes direction so that heavier elements in the air flow (debris) are thrown out of the air flow at the direction change to be caught in a trap. FIG. 20 shows an elbow type similar to the labyrinth filtering system in that a swift redirection of the air flow causes the largest particles to separate from the air flow, while the clean air flow continues toward the outlet. Like the labyrinth, this concept trades effectiveness for low noise, but requires space and contouring that may be difficult to achieve within the constraints of the vehicle package. FIG. 21 shows a fan embodiment. This is based on the effect that the air gets accelerated when passing by the fins, with the heavier debris getting thrown to the walls where they can then be filtered out from the air stream. This approach adds complexity, noise and turbulence caused by the fan.

In a second embodiment of the present invention, as discussed above, the counteractive air flow duct does not pass through the windshield and the ducting and outlet are positioned generally lower in the vehicle than in the first test embodiment discussed above. The second embodiment preferably has the duct outlet incorporated into the dashboard with the ducting therefore passing under or below a level of the windshield.

Such an embodiment can utilize a longer ducting system than the first test embodiment and can have one or more inlets positioned at the front of the vehicle, in the hood area, including the cowl zone, from the sides of the vehicle, from the side mirror areas, beneath the vehicle, or elsewhere on the vehicle to intake air from the external air stream when the vehicle is moving. Such inlets can be placed, inter alia, adjacent other intake ducts for the vehicle at the front of the vehicle, or as scoops or ducts (including NACA type ducts) incorporated into the hood or cowl of the vehicle or elsewhere.

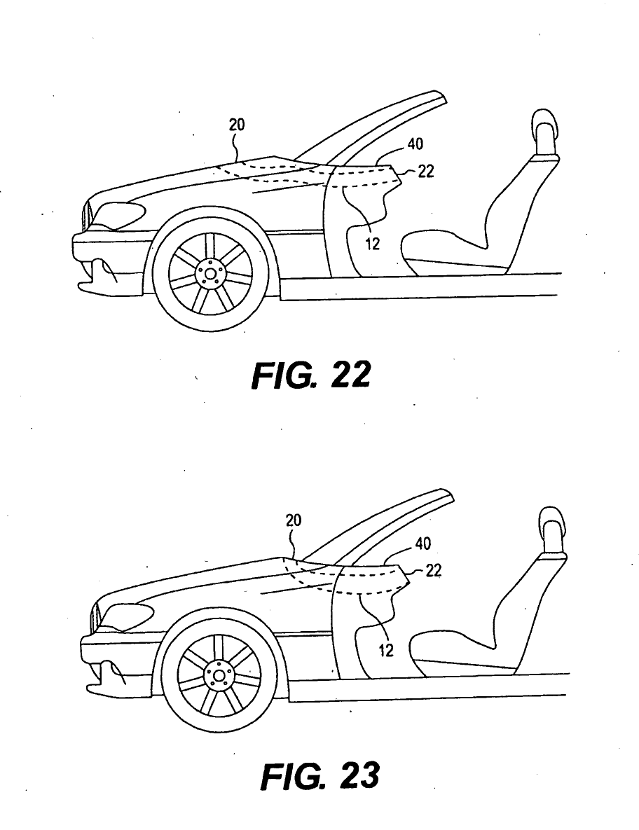

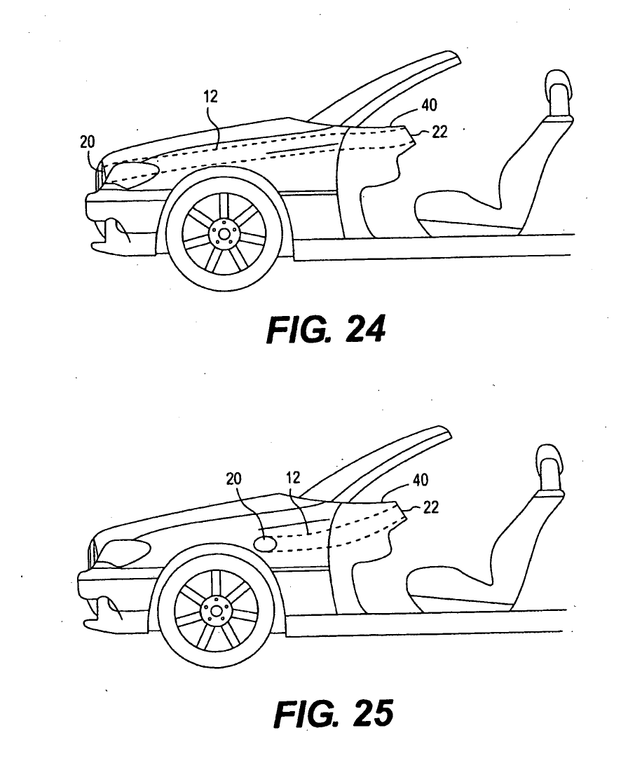

FIGS. 22-25 are partial schematic views of a two-seat convertible which show various alternative embodiments for the system of the present invention. FIG. 22 shows an arrangement where the inlet 20 is positioned on the hood and connects to ducting 12 (in phantom) which runs under the windshield to outlet 22 positioned in the dashboard 40. FIG. 23 shows an alternative arrangement where the inlet 20 is positioned in the cowl and connects to ducting 12 (in phantom) which runs under the windshield to outlet 22 positioned in the dashboard 40. FIG. 24 shows an alternative arrangement where the inlet 20 is positioned at the front of the vehicle (here shown behind the grill) and connects to ducting 12 (in phantom) which runs under the windshield to outlet 22 positioned in the dashboard 40. FIG. 25 shows an alternative arrangement where the inlet 20 is positioned at the side of the vehicle and connects to ducting 12 (in phantom) which runs under the windshield to outlet 22 positioned in the dashboard 40.

It has been found that to best counteract the bad wind in the cabin, the counteractive air flow through the system should correlate to the velocity of the vehicle. Thus, the inlet for the counteractive air flow system is preferably positioned so as to intake an air flow from the external air stream that correlates with the velocity of the vehicle. Otherwise, the invention would not be able to operate, since testing has shown, at least at the current time, no known blower system could provide the necessary air flow and velocity needed to effectively counteract the bad wind, especially at higher highway speeds, without being of such a large size or cost so as to be impractical. For instance, the blower systems currently used in automotive climate control systems are not powerful enough that they can even come close to providing an air flow sufficient to effectively counteract the bad wind in a convertible automobile, even at lower in-town speeds, and certainly not at higher highway speeds. One test made using a 12 amp 270 CFM blower from a leaf blower showed that even such a powerful blower provided insufficient air flow to effectively counteract the bad wind in the cabin. The ducting can reduce in cross-section from inlet to outlet to increase a velocity of the air therethrough.

Various aspects of the various embodiments described in this description can be combined in different combinations to form different embodiments, which embodiments are part of the present invention. The present invention is not limited to the disclosed embodiments. The invention can be applied to vehicles other than convertible automobiles to counteract bad wind or other undesirable/irritating air flows. In such situations, the ducting outlets will be positioned and directed as necessary to counteract the undesirable air flows.

What is claimed is:

1. A method for reducing undesirable air flow in a passenger compartment of a vehicle, comprising:
introducing at least one generally forward to rearward directed counteractive flow of air into the passenger compartment in an amount and at a velocity sufficient to counteract a rearward to forward flow of air occurring in the passenger compartment while the vehicle is moving forward.

2. The method of claim 1, wherein the counteractive flow of air is introduced at a forward portion of the passenger compartment.

3. The method of claim 1, wherein the counteractive flow of air is introduced at a generally laterally central portion of the passenger compartment.

4. The method of claim 3, wherein the counteractive flow of air is introduced through an outlet duct in a dashboard of the vehicle.

5. The method of claim 3, wherein the counteractive air flow is drawn from at least one inlet duct exposed to an exterior air stream that is pressurized when the vehicle is moving forward.

6. The method of claim 5, wherein the counteractive air flow is drawn from at least one inlet duct exposed to an exterior air stream that is pressurized and has a velocity proportional to a velocity of the vehicle when the vehicle is moving forward.

7. The method of claim 6, wherein the inlet duct is positioned forward of a vehicle windshield.

8. The method of claim 7, wherein the inlet duct is positioned at a front of the vehicle.

9. The method of claim 7, wherein the inlet duct is positioned on a hood of the vehicle.

10. The method of claim 7, wherein the inlet duct is positioned on a cowl of the vehicle.

11. The method of claim 7, wherein the inlet duct is positioned on a side of the vehicle.

12. The method of claim 7, and further connecting the inlet duct to the outlet duct with ducting that reduces in cross-sectional area between the inlet duct and the outlet duct to increase the velocity of the counteractive flow of air.

13. The method of claim 7, and further connecting the inlet duct to the outlet duct with ducting that runs beneath a surface of a hood of the vehicle.

14. The method of claim 1, wherein the counteractive flow of air counteracts a generally head level rearward to forward flow of air in the passenger compartment.

15. The method of claim 4, wherein the counteractive flow of air also counteracts a generally shoulder level rearward to forward flow of air in the passenger compartment.

16. The method of claim 4, wherein the counteractive flow of air counteracts the generally head and shoulder level rearward to forward flow of air in the passenger compartment to an extent that there is a forward to rearward flow of air around at least a portion of the head and shoulders of a front seat passenger.

17. The method of claim 1, and further comprising introducing a secondary forward to rearward directed counteractive flow of air into a longitudinally mid portion of the passenger compartment in an amount and at a velocity sufficient to cooperate with the at least one generally forward to rearward directed counteractive flow of air to counteract a rearward to forward flow of air occurring in the passenger compartment while the vehicle is moving forward.

18. The method of claim 1, where the amount and velocity of the counteractive flow of air are proportional to a speed of the vehicle.

19. The method of claim 1, wherein the vehicle is a two seat convertible automobile.

20. The method of claim 1, wherein the vehicle is a four seat convertible automobile.

21. The method of claim 1, and further comprising using a valving system to control an amount of the counteractive air flow.

22. The method of claim 1, and further comprising filtering the counteractive air flow to remove impurities.

23. An apparatus for reducing undesirable air flow in a passenger compartment of a convertible automobile, comprising:
at least one air inlet positioned external to the passenger compartment to tap into an air stream source;
at least one air outlet positioned at a front portion of the passenger compartment for introducing a frontward to rearward flow of air into the passenger compartment at a generally laterally central portion of the passenger compartment in an amount and at a velocity sufficient to counteract at least a portion of a rearward to forward flow of air in the passenger compartment to provide a forward to rearward directed flow of air adjacent a head of at least one front seat passenger;
at least one duct connecting the at least one air inlet to the at least one air outlet to supply air from the air stream source to the air outlet for introduction through the at least one air outlet into the passenger compartment.

24. The apparatus of claim 23, wherein the air outlet is positioned in a dashboard of the automobile.

25. The apparatus of claim 23, wherein the air inlet is exposed to an exterior air stream that is pressurized when the vehicle is moving forward.

26. The apparatus of claim 25, wherein the air inlet is exposed to an exterior air stream that is pressurized and has a velocity proportional to a velocity of the automobile when the automobile is moving forward.

27. The apparatus of claim 26, wherein the air inlet is positioned forward of an automobile windshield.

28. The apparatus of claim 27, wherein the air inlet is positioned at a front of the automobile.

29. The apparatus of claim 27, wherein the air inlet is positioned on a hood of the automobile.

30. The apparatus of claim 27, wherein the air inlet is positioned on a cowl of the automobile.

31. The apparatus of claim 27, wherein the air inlet is positioned on a side of the automobile.

32. The apparatus of claim 23, wherein the connecting duct reduces in cross-sectional area between the air inlet and the air outlet to increase the velocity of the counteractive flow of air.

33. The apparatus of claim 23, wherein the connecting duct runs beneath a surface of a hood of the automobile.

34. The apparatus of claim 23, wherein the counteractive air flow is sufficient to provide a forward to rearward flow of air around at least a portion of the shoulders of the front seat passenger.

35. The apparatus of claim 23, and further comprising a secondary air outlet to for introducing a forward to rearward directed counteractive flow of air into a longitudinally mid portion of the passenger compartment in an amount and at a velocity sufficient to cooperate with the air flow from the air outlet to assist in counteracting a rearward to forward flow of air occurring in the passenger compartment while the automobile is moving forward.

36. The apparatus of claim 23, where the amount and velocity of the counteractive flow of air from the air outlet is proportional to a speed of the automobile.

37. The apparatus of claim 23, wherein the convertible automobile is a two seat convertible automobile.

38. The apparatus of claim 23, wherein the convertible automobile is a four seat convertible automobile.

39. The apparatus of claim 23, and further comprising a climate control system connected to the apparatus to alter a temperature of the air exiting the air outlet.

40. The apparatus of claim 23, and further comprising a valving system for controlling the amount of air flow through the air outlet.

41. The apparatus of claim 23, and further comprising a filtering system connected to the apparatus to remove impurities from the counteractive air flow.

42. The apparatus of claim 23, wherein the apparatus is completely separate from a climate control system of the automobile.

43. A convertible automobile, comprising:
a passenger compartment;
a convertible roof that can be lowered/removed to expose an upper portion of the passenger compartment;
at least one air inlet positioned external to the passenger compartment to tap into an air stream source;
at least one air outlet positioned at a front portion of the passenger compartment for introducing a frontward to rearward flow of air into the passenger compartment at a generally laterally central portion of the passenger compartment in an amount and at a velocity sufficient to counteract at least a portion of a rearward to forward flow of air in the passenger compartment to provide a forward to rearward directed flow of air adjacent a head of at least one front seat passenger;
at least one duct connecting the at least one air inlet to the at least one air outlet to supply air from the air stream source to the air outlet for introduction through the at least one air outlet into the passenger compartment.

44. The convertible automobile of claim 43, wherein the automobile is a two seat automobile.

45. The convertible automobile of claim 43, wherein the automobile is a four seat automobile.

46. The convertible automobile of claim 43, wherein the air outlet is positioned in a dashboard of the automobile.

47. The convertible automobile of claim 43, wherein the air inlet is exposed to an exterior air stream that is pressurized when the vehicle is moving forward.

48. The convertible automobile of claim 47, wherein the air inlet is exposed to an exterior air stream that is pressurized and has a velocity proportional to a velocity of the automobile when the automobile is moving forward.

49. The convertible automobile of claim 48, wherein the air inlet is positioned forward of an automobile windshield.

50. The convertible automobile of claim 49, wherein the air inlet is positioned at a front of the automobile.

51. The convertible automobile of claim 49, wherein the air inlet is positioned on a hood of the automobile.

52. The convertible automobile of claim 49, wherein the air inlet is positioned on a cowl of the automobile.

53. The convertible automobile of claim 49, wherein the air inlet is positioned on a side of the automobile.

54. The convertible automobile of claim 43, wherein the connecting duct reduces in cross-sectional area between the air inlet and the air outlet to increase the velocity of the counteractive flow of air.

55. The convertible automobile of claim 43, wherein the connecting duct runs beneath a surface of a hood of the automobile.

56. The convertible automobile of claim 43, wherein the counteractive air flow is sufficient to provide a forward to rearward flow of air around at least a portion of the shoulders of the front seat passenger.

57. The convertible automobile of claim 43, and further comprising a secondary air outlet to for introducing a forward to rearward directed counteractive flow of air into a longitudinally mid portion of the passenger compartment in an amount and at a velocity sufficient to cooperate with the air flow from the air outlet to assist in counteracting a rearward to forward flow of air occurring in the passenger compartment while the automobile is moving forward.

58. The convertible automobile of claim 43, where the amount and velocity of the counteractive flow of air from the air outlet is proportional to a speed of the automobile.

59. The convertible automobile of claim 43, and further comprising a climate control system connected to the apparatus to alter a temperature of the air exiting the air outlet.

60. The convertible automobile of claim 43, and further comprising a valving system for controlling the amount of air flow through the air outlet.

61. The convertible automobile of claim 43, and further comprising a filtering system connected to the apparatus to remove impurities from the counteractive air flow.

62. The convertible automobile of claim 43, wherein the apparatus is completely separate from a climate control system of the automobile.
